(19) United States
(12) Patent Application Publication
(10) Pub. No.: US 2019/0168039 A1
(43) Pub. Date: Jun. 6, 2019

(54) AIR-PRESSURE CONTROLLED PISTON AND VALVE CONFIGURATION

(71) Applicant: Carroll G. Rowe, Washington, AR (US)

(72) Inventor: Carroll G. Rowe, Washington, AR (US)

(21) Appl. No.: 16/266,746

(22) Filed: Feb. 4, 2019

Related U.S. Application Data
(63) Continuation-in-part of application No. 15/714,276, filed on Sep. 25, 2017.
Application No. 15/714,276 is a continuation-in-part of application No. 15/206,037, filed on Jul. 8, 2016, now Pat. No. 9,891,635.
Application No. 15/206,037 is a continuation-in-part of application No. 15/493,415, filed on Apr. 21, 2017, now Pat. No. 10,203,705.
Application No. 15/493,415 is a continuation-in-part of application No. 15/714,406, filed on Sep. 25, 2017.
Application No. 15/714,406 is a continuation-in-part of application No. 15/206,037, filed on Jul. 8, 2016, now Pat. No. 9,891,635.
Application No. 15/206,037 is a continuation-in-part of application No. 15/493,415, filed on Apr. 21, 2017, now Pat. No. 10,203,705.
(60) Provisional application No. 62/190,630, filed on Jul. 9, 2015.
(60) Provisional application No. 62/190,630, filed on Jul. 9, 2015.
(60) Provisional application No. 62/326,056, filed on Apr. 22, 2016.
(60) Provisional application No. 62/333,451, filed on May 9, 2016.

(51) Int. Cl. A62C 5/02; G05D 16/10; G05D 16/16; F16K 17/22; F16K 31/122; F16K 17/168

(52) U.S. Cl. CPC A62C 5/02; G05D 16/107; G05D 16/103; F17C 2205/0338; F16K 17/22; F16K 31/122; F16K 17/168; G05D 16/166

(57) ABSTRACT

A pressurized-fluid controlled pressure regulator includes a piston configured to slide within the pressure regulator, a plate of the piston positioned in and separating a pressure chamber into two sections and a shaft of the piston extending from the plate out of the pressure chamber and into a liquid flow chamber, wherein the introduction of liquid into the liquid flow chamber exerts a force on the piston shaft, moving the piston to an open position, and wherein the introduction of various amounts of pressurized fluid into the different sections of the pressure chamber allows for selective movement of the piston between a closed position and open position.

### CROSS-REFERENCE TO RELATED APPLICATIONS

This application is a continuation-in-part of U.S. patent application Ser. No. 15/714,276, filed on Sep. 25, 2017, and entitled “Pressure Regulating Valve with Incorporated Shut-Off Mechanism and Fluidic Bypass”, which is a continuation-in-part of (a) allowed U.S. patent application Ser. No. 15/206,037, filed on Jul. 08, 2016, and entitled “Dual-Piston Pressure Reducer”, which claims priority to U.S. Provisional Patent Application No. 62/190,630 and has issued into U.S. Pat. No. 9,891,635 and (b) U.S. patent application Ser. No. 15/493,415, filed on Apr. 21, 2017, and entitled “Pressure Reducing Valve with Incorporated Shut-Off Mechanism”, which claims priority to U.S. Provisional Patent Nos. 62/190,630, 62/326,056, and 62/333,451. This application is also a continuation-in-part of U.S. patent application Ser. No. 15/714,406, filed on Sep. 25, 2017, and entitled “Pressure Regulating Valve with Multi-Pronged Piston Assembly,” which is also a continuation-in-part of U.S. patent application Ser. No. 15/206,037 and U.S. patent application Ser. No. 15/493,415. All of such applications are incorporated by reference herein in their entireties.

### STATEMENT REGARDING FEDERALLY SPONSORED RESEARCH OR DEVELOPMENT

Not applicable.

### BACKGROUND OF THE INVENTION

Pressure control valves, or pressure regulators, are used to automatically increase, decrease, turn on, turn off, or otherwise regulate the flow of a liquid or gas at certain pressures. In many cases, these valves serve to maintain a reduced outlet pressure regardless of variations in the inlet pressure of the fluid. These types of pressure reducing valves are used primarily for safety purposes and can be implemented in a variety of areas, including the aircraft industry, cooking, the oil and gas industry, and many others. In one application, pressure control valves are used in compressed air foam systems (CAFS) used for firefighting, in which the value may be used to deliver an appropriate quantity of water or a mixture of water and surfactant. Many existing pressure control valves and regulators use a spring loaded poppet valve as the pressure reducing or restrictive element and a diaphragm to sense the pressure changes. A spring is typically used to exert a force on the sensing element and to open the valve.

In many cases, fire apparatuses are used in areas of both high pressure hydrants, where it is advantageous to reduce the pressure from the hydrants to the apparatus, and of low pressure hydrants, where it is not advantageous to reduce the pressure from the hydrants. One example would be area of different altitudes, where at lower levels there is more pressure due to the higher head of the water (and vice versa for higher altitude portions of the area). For cases where pressure may vary during use or by use, it is necessary to provide optional means of regulation, where the operator may selectively choose the operation best suited for the particular situation.

### BRIEF SUMMARY OF THE INVENTION

The present invention is directed to a pressure control valve or flow regulator with an incorporated shut-off mechanism for use between a pressurized liquid source and a pump inlet (the pump inlet being fluidically connected to the pressure regulator outlet). The flow regulator uses a piston with a plate, whereupon application of a pressurized fluid on the plate controls movement of the piston. Rather than a poppet valve, the piston moves axially within a pressure chamber as the pressure regulating component. The piston is capable of moving freely toward and away a sealing port allowing the user to control liquid flow to the flow outlet area. The piston, when positioned entirely forward such that it contacts the sealing port, is able to prevent the flow of liquid into the outlet area altogether. In alternate embodiments, a diaphragm may replace the piston and functional in substantially the same manner. For purposes of describing the invention, however, the term piston will be used.

In the preferred embodiment of the present invention, the pressure regulator is fluidically connected to a pressurized fluid supply (such as a pressurized air supply). While it is contemplated that any pressurized fluid may be used (such as air, water, or some other fluid), for ease of describing the invention, various embodiments may be described with reference to pressurized air. The invention, however, is not so limited. More preferably, the pressure regulator is fluidically connected at two points (one on either side of the piston plate), such that application of varying amounts of pressurized fluid on either side of the plate will control the lateral movement of the plate within the pressure chamber. When used in a compressed air foam system, the invention allows the engine powering the system to run at an increased rpm at the same discharge pressure. This provides numerous advantages in practical firefighting applications.

In certain implementations of the pressure regulator of the present invention, the flow regulator may further include a hand wheel attached at the rear of the pressure chamber. By turning the hand wheel, a moveable plate within the pressure chamber is brought forward, and thus the available stroke of the piston is reduced. This provides a manual override function for the regulator. When the hand wheel is turned such that the moveable plate is in the most forward position, the piston is held in place against the sealing port such that the flow is cut off entirely; conversely, when the hand wheel is turned such that the moveable plate is in the fully rearward position, full articulation of the piston is possible, thereby allowing full flow through the regulator.

These and other features, objects and advantages of the present invention will become better understood from a consideration of the following detailed description of the preferred embodiments and appended claims in conjunction with the drawings as described following:

### BRIEF DESCRIPTION OF THE DRAWINGS

FIG. 1 shows a first embodiment of the pressure regulator of the present invention in partial cut-away, showing the piston in a closed position.

FIG. 2 shows a first embodiment of the pressure regulator of he present invention in partial cut-away, showing the piston in a partially open position.

FIG. 3 shows a first embodiment of the pressure regulator of the present invention in partial cut-away, showing the piston in a fully open position.

FIG. 4 shows a second embodiment of the pressure regulator of the present invention in partial cut-away, showing the piston in a closed position.

FIG. 5 shows a second embodiment of the pressure regulator of the present invention in partial cut-away, showing the piston in a partially open position.

FIG. 6 shows a second embodiment of the pressure regulator of the present invention in partial cut-away, showing the piston in a fully open position.

FIG. 7 shows a third embodiment of the pressure regulator of the present invention in partial cut-away, showing a controller connected to the pressure regulator for controlling pressure into the pressure chamber of the pressure regulator, the controller being in a first mode configuration.

FIG. 8 shows a third embodiment of the pressure regulator of the present invention in partial cut-away, showing a controller connected to the pressure regulator for controlling pressure into the pressure chamber of the pressure regulator, the controller being in a second mode configuration.

FIG. 9 shows a third embodiment of the pressure regulator of the present invention in partial cut-away, showing a controller connected to the pressure regulator for controlling pressure into the pressure chamber of the pressure regulator, the controller being in a third mode configuration.

FIG. 10 shows a fourth embodiment of the pressure regulator of the present invention in partial cut-away, showing a lever, cylinder, and spring assembly for controlling pressure, the lever being in a first position.

FIG. 11 shows a fourth embodiment of the pressure regulator of the present invention in partial cut-away, showing a lever, cylinder, and spring assembly for controlling pressure, the lever being in a second position.

FIG. 12 shows a fourth embodiment of the pressure regulator of the present invention in partial cut-away, showing a lever, cylinder, and spring assembly for controlling pressure, the lever being in a third position.

### DETAILED DESCRIPTION OF THE PREFERRED EMBODIMENT(S)

The present invention is directed toward a single-piston pressure regulator with incorporated shut off mechanism. The pressure regulator may be manufactured as a single integrated piece or may be manufactured as separate pieces that are connected together to form the pressure regulator assembly. For ease of describing the invention, the components of the pressure regulator may be described herein as being connected. It is understood, however, that the description of elements equally applies to the embodiment in which the components are individually pieces joined together to form the assembly.

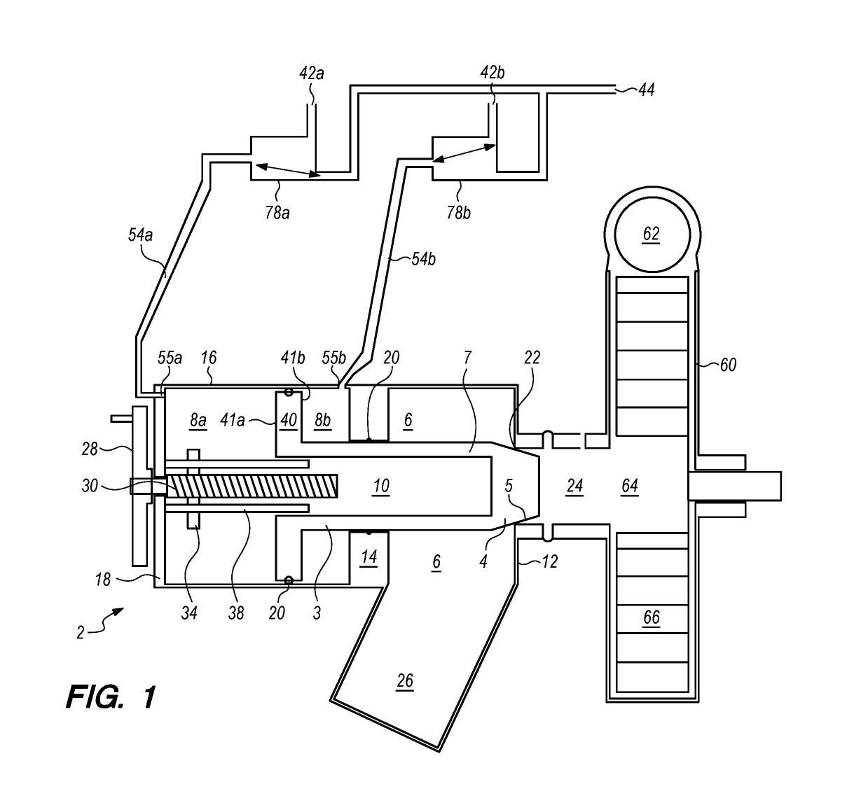

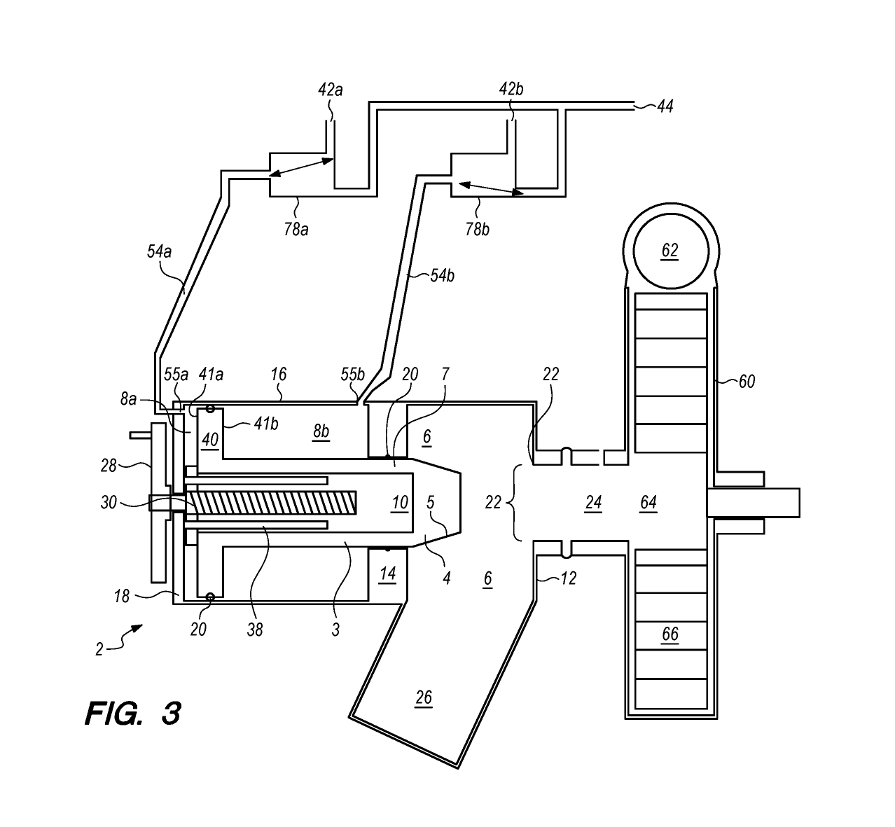

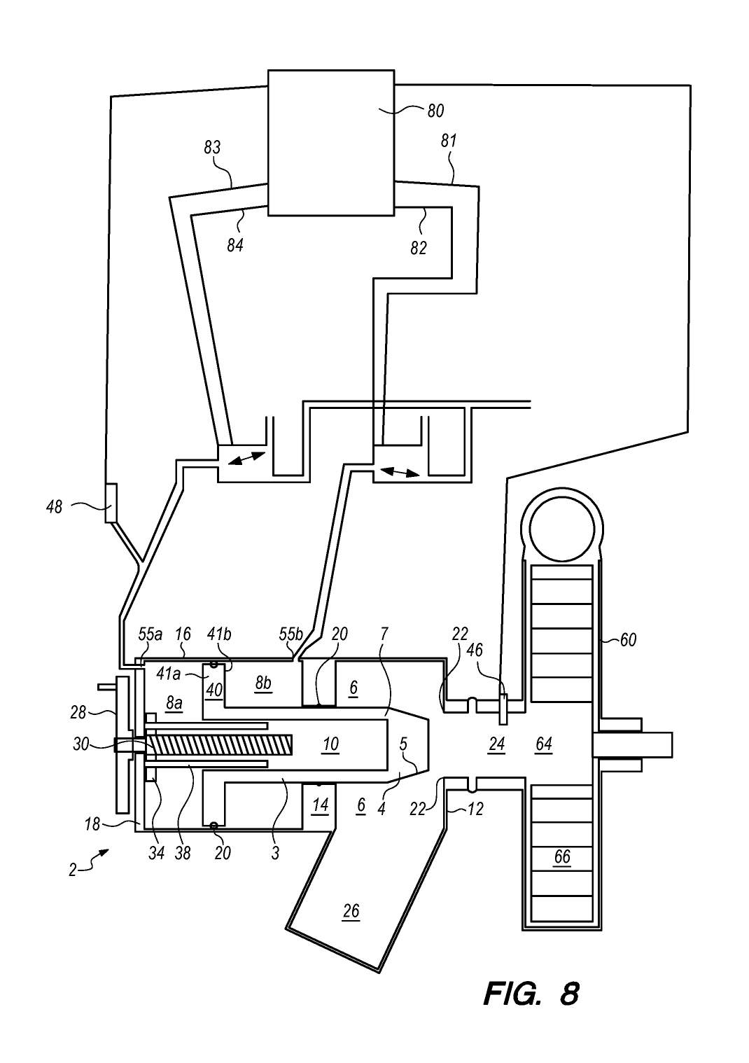

With regards to FIGS. 1-12, the general configurations for various embodiments of the pressure regulator 2 of the present invention may be described. The pressure regulator 2 generally comprises a liquid flow inlet area 26 connected to a liquid flow outlet area 24 through a liquid flow chamber 6. A sealing port 22 is positioned adjacent the liquid flow chamber 6 (either between the flow outlet area 24 and the liquid flow chamber 6, as shown in FIGS. 1-3, or the flow inlet area 26 and liquid flow chamber 6, as shown in FIGS. 3-6, depending on embodiment implemented). The pressure regulator 2 also includes a pressure chamber 8 and a piston 3. The piston 3 preferably has a shaft 7 and a face plate 40, the face plate 40 of the piston 3 being positioned inside the pressure chamber 8 such that the pressure chamber 8 is separated into a forward pressure chamber 8b and a rearward pressure chamber 8a by the plate. The shaft 7 of the piston 3 extends from the pressure chamber 8 into the liquid flow chamber 6. A head cap 18 encloses the rearward pressure chamber 8a, and in some embodiments, a hand wheel assembly extends from outside the pressure chamber 8 into the pressure chamber 8. These elements are generally enclosed in a housing (preferably a metal housing).

In one embodiment, the flow inlet area 26 is at a generally 45° angle to the liquid flow chamber 6, as shown in FIGS. 1-3. Alternatively, the flow inlet area 26 may run parallel to the liquid flow area 6, as shown in FIGS. 3-6. In yet another embodiment (not shown) the flow inlet area 26 may be substantially perpendicular to the liquid flow chamber 6. It is also contemplated that the flow inlet area 26 may be positioned between the pressure chamber 8 of the regulator 2 and the flow outlet area 24 (FIGS. 1-3, wherein the pressure chamber 8 is on a first side of the inlet chamber 26 and liquid flow chamber 6 and the flow outlet area 24 is on the opposite side), or alternatively, that the flow outlet area 24 is positioned between the flow inlet flow area 26 and the pressure chamber 8 (FIGS. 3-6, wherein the pressure chamber 8 and flow inlet area 26 are on opposite sides of the liquid flow chamber 6 and flow outlet area 24). In any event, the functioning of the regulator 2 is substantially the same—a piston 3 moves within the regulator 2 to open and close the liquid flow chamber 6, allowing varying degrees of liquid flow through the liquid flow chamber 6 and out through the outlet flow area 24 into, for example, a pump suction inlet 64. It is understood that any other configuration is within the scope of the invention, and various such configurations may be required in order to fit within available space, particularly in tight-fitting applications such as on a firetruck with CAFS equipment.

A piston 3 is situated inside the regulator 2 and is fitted to slide longitudinally within the regulator 2 along an axis that extends along the centerline of the regulator 2. The piston 3 includes a plate 40 and a shaft 7 extending from one side of the plate 40. The piston 3 has a number of faces that are positioned in different areas of the regulator 2: a forward face 41b of the plate 40, a rearward face 41a of the plate 40, and a forward face 4 on the shaft 7. In one embodiment, the shaft 7 may also include a beveled or tapered edge 5 on its forward face 4, as shown in FIGS. 1-3. These faces and beveled portion act as points on the piston 3 on which fluids (either the pressurized fluid in the pressure chamber 8 or the liquid in the liquid flow chamber 6) exert forces on the piston 3 causing the piston 3 to move within the regulator 2. The piston 3 is positioned inside the regulator 2 such that the plate 40 of the piston 3 is positioned inside of the pressure chamber 8 and the shaft 7 of the piston extends from the pressure chamber 8 through a dividing wall 40 and into the liquid flow chamber 6. Sealing elements 20 may be positioned between the piston shaft 7 and opening in the dividing wall 40 to prevent flow of fluid through the dividing wall 40 between the pressure chamber 8 and liquid flow chamber 6.

As mentioned above, the plate 40 of the piston 3 has a forward face 41b and a rearward face 41a. In the preferred embodiment, the diameter of the plate 40 of the piston 3 is substantially close to the diameter of the pressure chamber 8 such that the side surfaces of the plate 40 substantially create a seal with the walls 16 of the pressure chamber 8. Sealing elements 20 may be included between the side walls of the plate 40 and the walls 16 of the pressure chamber 8 to further facilitate sealing. These sealing elements 20 provide a fluid-tight seal, which allows the piston 3 to move along its longitudinal axis while preventing fluid from flowing between the outer surfaces of the plate 40 and the inner surface of the pressure chamber 8. Thus, because the plate 40 of the piston 3 creates a seal with the inner walls 16 of the pressure chamber 8, the pressure chamber 8 is effectively divided into two portions, a rearward pressure chamber 8a and a forward pressure chamber 8b—one on either side of the plate 40 of the piston 3 such that the rearward face 41a of the plate 40 is positioned inside the rearward chamber 8a and the forward face 41b of the plate 40 is positioned inside the forward chamber 8b. As described above, in one embodiment the shaft 7 has a forward face 4 and an adjacent beveled edge 5. The forward face 4 of the shaft 3 (and the adjacent beveled area 5) is situated inside the liquid flow chamber 6.

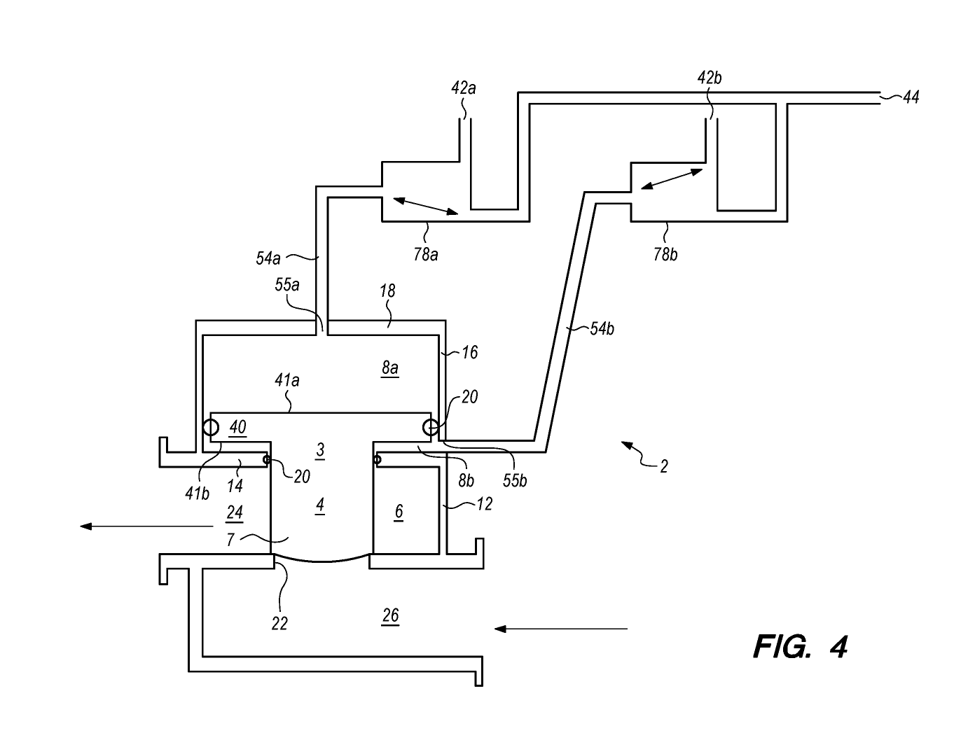

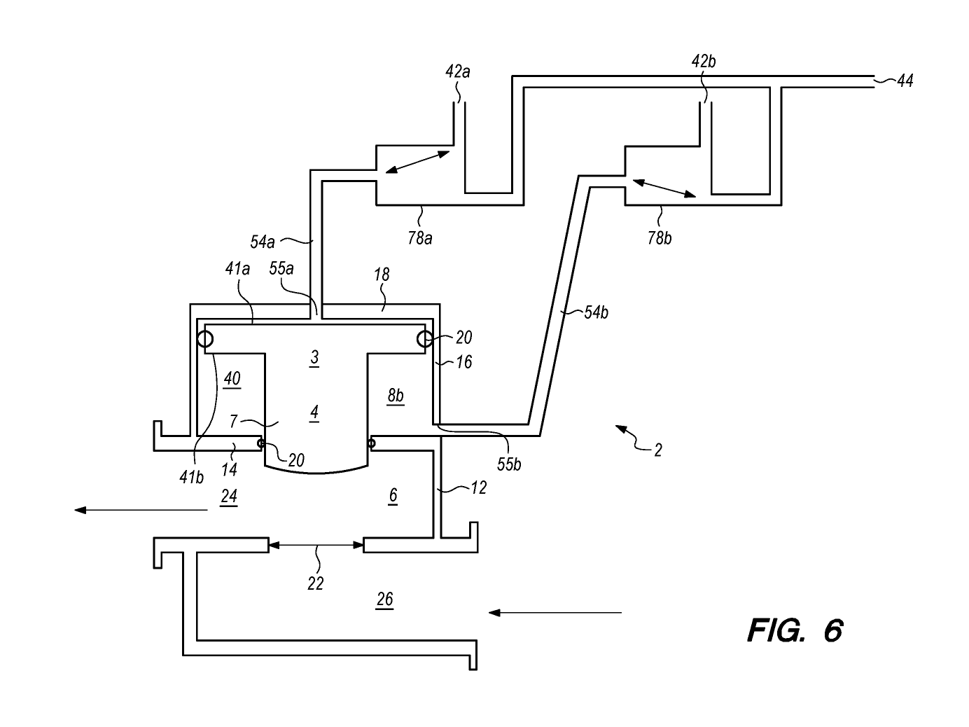

The flow inlet area 26 is configured to receive a liquid from a pressurized liquid source (not shown). The source may be, for example, a water tank, or water that is mixed with a surfactant either in a tank, or in a line that feeds the water from the tank to flow inlet area 26. The flow inlet area 26 is fluidically connected to the liquid flow chamber 6, which separates the flow inlet area 26 from the flow outlet area 24. A portion of the shaft 7 of the piston 3 is positioned inside the liquid flow chamber 6 and is configured to move within the liquid flow chamber 6 such that the regulator 2 moves between a fully opened position (as shown in FIGS. 3 and 6) and a fully closed position (as shown in FIGS. 1 and 4). The fully closed position is characterized as the piston 3 being in the most forward position such that the forward face 4 of the piston's shaft 7 creates a seal with the sealing port 22, thereby preventing liquid flow through the liquid flow chamber 6. The fully open position is characterized as the piston 3 being positioned as far rearward as possible, thereby allowing maximum liquid flow into the liquid flow chamber 6 from the inlet area 26 and out of the liquid flow chamber 6 through the outlet area 24. The piston 3 may move to any position between the fully open position and fully closed position such that the forward face 4 of the shaft 7 of the piston 3 is at varying positions relative to the sealing port 22. As the forward face 4 of the shaft 7 of the piston 3 moves toward or away from the sealing port 22, varying amounts of liquid flow through the liquid flow chamber 6 is allowed, thereby regulating the liquid flow through the regulator 2.

The liquid flow chamber 6 includes a sealing port 22 that works in conjunction with the piston 3 to seal the liquid flow chamber 6 and prohibit liquid flow through the liquid flow chamber 6. In one embodiment, the sealing port 22 is positioned between the liquid flow chamber 6 and the flow outlet area 24 such that when the piston 3 moves to its most forward position, liquid may enter at least a portion of the liquid flow chamber 6 through the flow inlet area 26, but cannot exit through the flow outlet area 24 because the sealing port 22 is closed by the piston 3 (as shown in FIGS. 1-3, wherein sealing port 22 is positioned between the liquid flow chamber 6 and flow outlet area 24). In an alternate embodiment, as shown in FIGS. 3-6, the sealing port 22 is positioned between the liquid flow chamber 6 and the flow inlet area 26 such that liquid is prohibited from entering the liquid flow chamber 6 entirely (and thus also prohibiting liquid from exiting the regulator through the flow outlet area 24 into the pump). In one embodiment of the pressure regulator 2 of the present invention, the sealing port 22 may incorporate a beveled sealing element to further facilitate sealing of the sealing port 22, such that the beveled face 5 of the piston 3 fits into the beveled sealing element, thereby creating a better seal. In one embodiment, this sealing element may be a valve seat located at the sealing port 22, the valve seat being manufactured integral to the regulator housing. As noted above, in one embodiment the pressure regulator 2 may comprise a number of separate pieces that are mechanically connected. In such an embodiment, the sealing element may be an outlet ring that is connected to the regulator housing after manufacture, the outlet ring serving as both the sealing port 22 and flow outlet area 24.

As indicated, the piston 3 is configured to move within the regulator 2 between open and closed positions due to pressures exerted on the various piston faces by the liquid flowing through the liquid flow chamber 6 and by a pressurized fluid introduced into the pressure chamber 8. In the preferred embodiment, a pressurized fluid source 44 is used to regulate the pressure of the fluid flowing into the pressure chamber 8. While it is understood that various applications may be used (such as pneumatic or hydraulic), because the preferred embodiment utilizes pneumatic pressure, the invention will be described using a description of a pneumatic pressure application. In the preferred embodiment, the regulator 2 is fluidically connected to a pressurized air source 44, preferably having two lines 54a. 54b for transmitting air from the pressurized air source 44 into the pressure chamber 8 of the regulator 2. One of the air supply lines 54a is preferably connected to the rearward pressure chamber 8a and the other air supply line 54b is connected to the forward pressure chamber 8b, such that pressurized air may be introduced into each chamber 8a, 8b independently. A valve 78a, 78b on each air supply line 54a, 54b allows for the selective operation of each air supply line 54a, 54b independently, allowing the operator to modify the amount of pressurized air introduced into each pressure chamber 8a, 8b. Varying the pressure introduced into either chamber 8a, 8b allows for the selective movement of the piston 3 within the regulator 2, allowing more precise regulation of liquid flow through the regulator 2. Further, the ability to introduce pressurized air on the forward face 41b of the piston plate 40 allows for a “dampening” effect on the movement of the piston 3. It is understood that as the piston 3 moves between its open and closed positions, the area on which the liquid flowing into the liquid flow chamber 6 exerts force on the piston shaft 7 changes (as more or less of the forward face 4 of the shaft 7 of the piston 3 is now disposed to the liquid). Though this change is minimal, this coupled with the changes in the supply pressure of the liquid as flow increases, results in variation of pressure at the pump inlet 64. While in most instances this does not present a problem, in foam applications, it does cause some variation in foam to water ratio. For this reason, the ability to variable introduce pressure into the forward pressure chamber 8b allows for the dampening or cushioning effect. The ability to vary the pressure on each side of the plate 40 allows for the resistance to opening or closing of the valve to be maintained in a balanced state during operation. For example, should the liquid flow pressure decrease during operation and the pressure in the rear pressure chamber 8b remain the same, without introduction of pressure into the forward pressure chamber 8a, the piston 3 would necessarily move toward a closed position. Introduction of pressure into the forward pressure chamber 8b can prohibit this undesired movement.

As noted above, in one embodiment of the pressure regulator 2 of the present invention, the pressure regulator 2 uses a wheel 28 to control the movement capabilities of the piston 3. In one embodiment, a substantially circular hand wheel 28 may be implemented. It is understood that any variation of wheel shape may be used, so long as the wheel 28 may be used to rotate a threaded shaft 30 connected to the wheel 28, thereby moving a plate 34 in a forward or rearward direction to change the area in which the piston 3 may move. The hand wheel 28 is connected to one end of the threaded shaft 30, while the plate 34 is located at the other end of the threaded shaft 30. As indicated above, a head cap 18 is connected to the rear pressure chamber 8a and this head cap 18 serves to enclose the rear pressure chamber 8a. This head cap 18 may be manufactured integral to the housing of the rear pressure chamber 8a or may be a separate piece positioned between the moveable plate 34 and the hand wheel 28 that is configured to be fitted, by welding, bolts, or other means to the end of the rear pressure chamber 8a. In either event, the head cap 18 is configured such that the threaded shaft 30 extends through the head cap 18 and into the rear pressure chamber 8a. The hand wheel 28 preferably remains on the exterior of the rear chamber 8a housing such that the wheel 28 can be accessed by the user during use of the regulator 2. The rotation of the hand wheel 28 by the user in turn causes the threaded shaft 30 to rotate, thus causing the movable plate 34 to move forward or rearward in the rear pressure chamber 8a.

In one embodiment, the threaded shaft 30 may extend from the hand wheel 28 into a hollow portion 10 of the piston 3. This hollow portion 10 of the piston 3 is designed to receive the end of the threaded shaft 30, but not to contact the threaded shaft 30 so that the piston 3 is not prohibited from sliding by the threaded shaft 30. In one embodiment, guide pins 38 are used to prohibit the movable plate 34 from rotating as the threaded shaft is rotated 30, thus allowing the plate 34 to only move forward or rearward depending on the rotation of the hand wheel 28. The guide pins 38 are preferably threaded into the end cap 18 at one end with the other ends extending through the moveable plate 34. In one embodiment, the guide pins 38 extend into hollow area 10 of the piston 3 to secure the piston 3 to the guide pins 38 while also allowing piston 3 to move freely toward and away from the sealing port 22 in order to control the flow of fluid in the fluid flow chamber 6. The outer diameter of the moveable plate 34 is such that it will engage the rear face 41a of the piston 3 as the plate 34 moves forward, thus limiting the rearward movement of piston 3. As the plate 34 continues to move into the rearward face 41a of the piston 3, the plate 34 forces the piston 3 into the sealing port 22, thereby preventing flow of water through the fluid flow chamber 6 altogether.

Thus, it may be seen that the hand wheel 28 provides a manual means to override the automatic pressure regulation of the regulator 2. By turning hand wheel 28, movable plate 34 may be moved forwardly or rearwardly depending upon the direction of rotation. Using right hand threads, turning hand wheel 28 clockwise would cause movable plate 34 to more forwardly, but the invention is not so limited. It may be seen that the position of movable plate 34 within the interior of the rear chamber 8a provides a stop to the maximum rearward movement of piston 3, and thus provides a manual override function to the degree to which the valve may open under automatic operation. If hand wheel 28 is turned such that movable plate 34 is fully forward, then it presses the forward face 4 of the shaft 7 of the piston 3 (and the beveled edge area 5) fully against the sealing port 22, thereby stopping the passage of liquid through fluid flow chamber 6 and out of the outlet area 24, and therefore stopping all flow through the regulator 2. Although the hand wheel 28 is shown as a manually controlled wheel in the illustrated implementation, various electronic, hydraulic, pneumatic, or other powered control means could be used to actuate the position of moveable plate 34.

The structure of the regulator 2 having now been described, its operation may be described as follows. Generally speaking, a first pressurized liquid flows from a pressurized liquid source (not shown) into the liquid flow chamber 6 through the flow inlet area 26. This flow of liquid exerts a pressure at the forward face 4 of the piston shaft 7, which is positioned inside the liquid flow chamber 6. In one embodiment, pressure is also exerted on the beveled portion 5 of the piston's shaft 7. This exertion of pressure on the forward face 4 and beveled portion 5 of the shaft 7 moves the piston rearward into the pressure chamber 8 (i.e. moving toward the fully open position), which serves to open the valve to allow flow through the liquid flow chamber 6 and out through the flow outlet area 24.

As the piston 3 moves into the pressure chamber 8, the user may selectively introduce pressurized air (or another pressurized fluid) into the pressure chamber 8 through the pressurized air inlets 55a, 55b located within the separate portions 8a, 8b of the pressure chamber 8 and fluidically connected to the pressurized air supply 44 (or other pressurized fluid supply) through the supply lines 54a, 54b. As pressurized air is introduced into the rearward pressure chamber 8a the pressure builds in the rear pressure chamber 8a. As the pressure in the rear pressure chamber 8a builds, the air exerts a force on the rear face 41a of the piston plate 40. Once the pressure exerted on the rear face 41a of the piston plate 40 increases to a certain point (sufficient to overcome the force exerted by the liquid at the front face 4 of the piston shaft 3), the piston 3 is pushed back forward. The piston 3 may continue to move forward until the pressures at the rear face 41a of the piston plate 40 and at the front face 4 and beveled portion 5 of the piston shaft 7 equalize, thus creating a regulation of the pressure of fluid that flows out of the outlet flow area 24 of the regulator. The precise position at which the piston 3 reaches equilibrium may be modified by varying the areas of the forward parts of the piston shaft 3 (forward face 4 and beveled portion 5) proportionally to the area of the rear face 41a of the piston plate 40. In one embodiment, the rearward face 41a of the piston plate 40 has a diameter of 6″ whereas the diameter of piston shaft 3 is 4 ½″ and the diameter of the beveled portion 5 is 3 ¾″. Because the area onto which fluid pressure may be asserted is greater at the rear of the piston 3 (i.e. rear face 41a of the plate 40) than the area at the front of the piston 3 (i.e. the face 4 of the shaft 7 and beveled portion 5 of the shaft 7), it may be seen that as pressure builds behind the rear face 41a of the piston plate 40 due to introduction of a pressurized fluid into the rear pressure chamber 8a, the pressure to force piston 3 rearward (and thereby regulate flow through the regulator 2) will increase.

To further overcome the pressure exerted at the rear face 41a of the plate 40 by the pressurized fluid introduced into the rear chamber 8a, the user may selectively introduce pressurized fluid into the forward pressure chamber 8b from the same pressurized fluid source 44 or from a different pressurized fluid source. The pressurized fluid may then exert a force on the forward face 41b of the plate 40 in a direction opposite the force exerted at the rear face 41a of the plate 40. This pressure exerted on the forward face 41b of the piston plate 40 may work with the pressure exerted on the shaft 7 by the fluid flowing in the fluid flow chamber 6 to balance the pressure exerted in the rear pressure chamber 8a. The pressure introduced on either side 8a, 8b of the pressure chamber 8 can be selectively controlled such that flow regulation of the fluid through the fluid flow chamber 6 can be selectively regulated as desired.

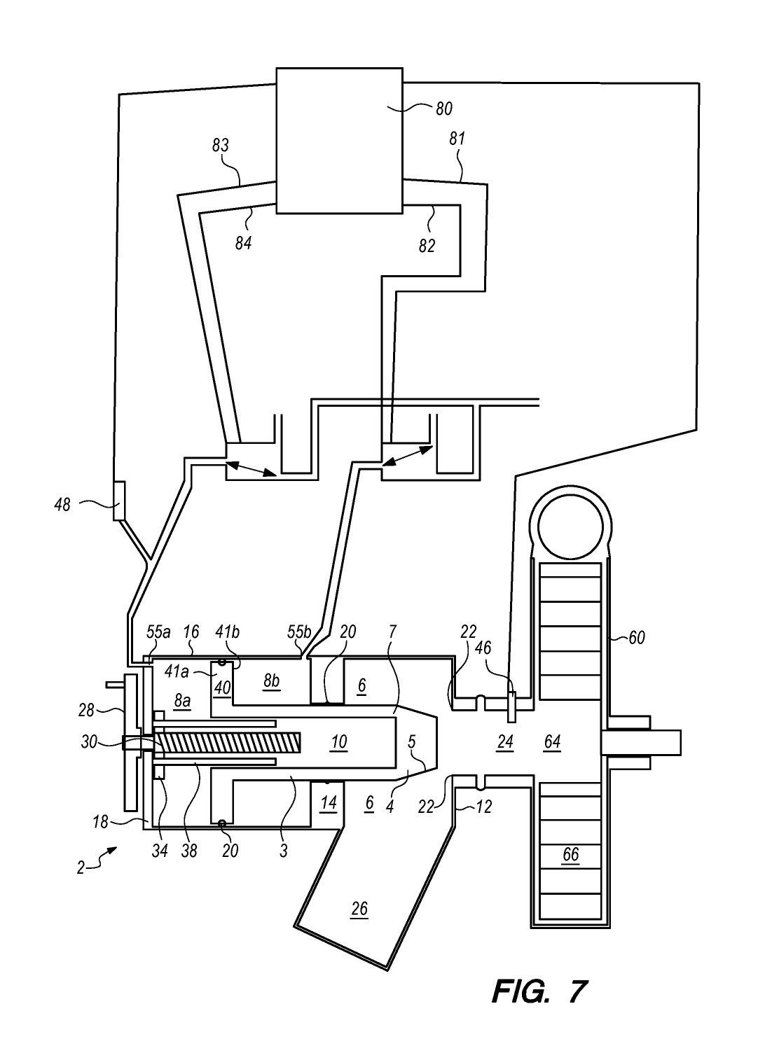

In one embodiment, the degree of pressurized fluid introduced into the various sides 8a, 8b of the pressure chamber 8 may be selectively (or automatically) controlled by a controller 80 in communication with a microprocessor. The use of a microprocessor capable of changing rates of the pressurized fluid source several times a second allows for a constant adjustment regulation rate through the regulator 2, allowing for appropriate flow through the regulator 2 within a very tight window. In one embodiment, a pressure switch or transducer may 46 be located in the outlet flow area 24 to provide a signal to the controller 80 (or user, if manual control of pressure is implemented) to modify the pressure introduced into the various sides 8a, 8b of the pressure chamber such that the pressures can be balanced at the desired flow rate, as shown in FIGS. 7-9.

In various embodiments, the pressurized air supply lines 54a, 54b may each include a valve 78a, 78b for selective operation of the air supply line 54a, 54b, allowing the user to selectively control the introduction of pressurized air into each pressure chamber 8a, 8b of the regulator 2. The valves 78a, 78b may also include vents 42a, 42b, allowing pressurized air to be released through the valve 78a, 78b, which may, for example, be useful for bleeding air from the supply hose or releasing air from the portion 8a, 8b of the pressure chamber 8 fluidically connected to that particular air supply line 54a, 54b and valve 78a, 78b. By independently controlling each air supply line 54a, 54b and valve 78a, 78b to either its supply position (wherein pressurized air is introduced through the line into the pressure chamber 8a, 8b) or its vent position (wherein pressurized air is vented from the pressure chamber 8a, 8b through the air supply line 54a, 54b and valve 78a, 78b), various modes of operation of the regulator 2 may be selectively achieved as desired by the user.

For example, in a first mode configuration, as shown in FIGS. 1, 4, and 7, the regulator 2 may be moved toward the closed position by selectively positioning the valve 78a associated with the rear pressure chamber 8a supply line 54a to the supply position and selectively positioning the valve 78b associated with the forward pressure chamber 8b supply line 54b in the vent position (such as the forward pressure chamber 8b vents through the supply line 54b and out of the vent 42b in the valve 78b). This first mode configuration allows the piston 3 to move to the closed position as the pressure in the rear chamber 8a builds and overcomes the pressure exerted by the liquid flowing into the regulator 2 on the shaft 7 of the piston 3 (as no pressure is applied in forward pressure chamber 8b to dampen or overcome the pressure in rearward pressure chamber 8a). In a second mode configuration, which is shown in FIGS. 3, 6 and 8, the piston may be moved toward the open position to allow for full flow of liquid out of the regulator 2 by selectively positioning the valve 78a associated with the rear pressure chamber 8a in the vent position and positioning the valve 78b associated with the forward pressure chamber 8b in the supply position. In this second mode configuration, pressure in the forward pressure chamber 8b builds and acts against the forward face 41b of the piston plate 40, pushing the piston 3 rearward in the regulator 2 and allowing fully flow of liquid through the liquid flow chamber 6 because there is no pressure in rear pressure chamber 8a to overcome the pressure applied in forward pressure chamber 8b.

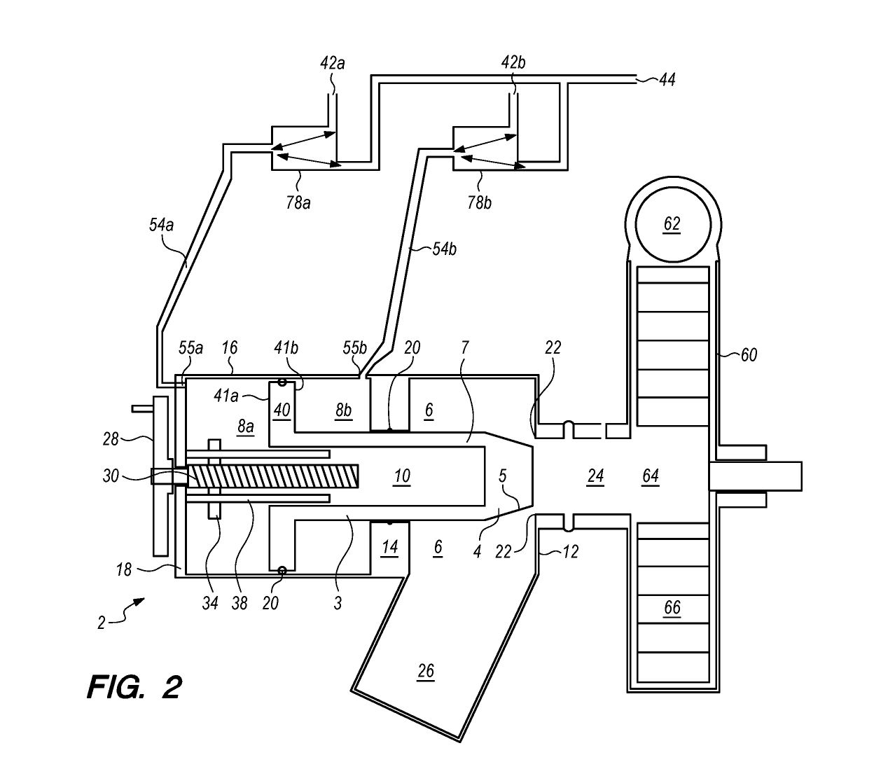

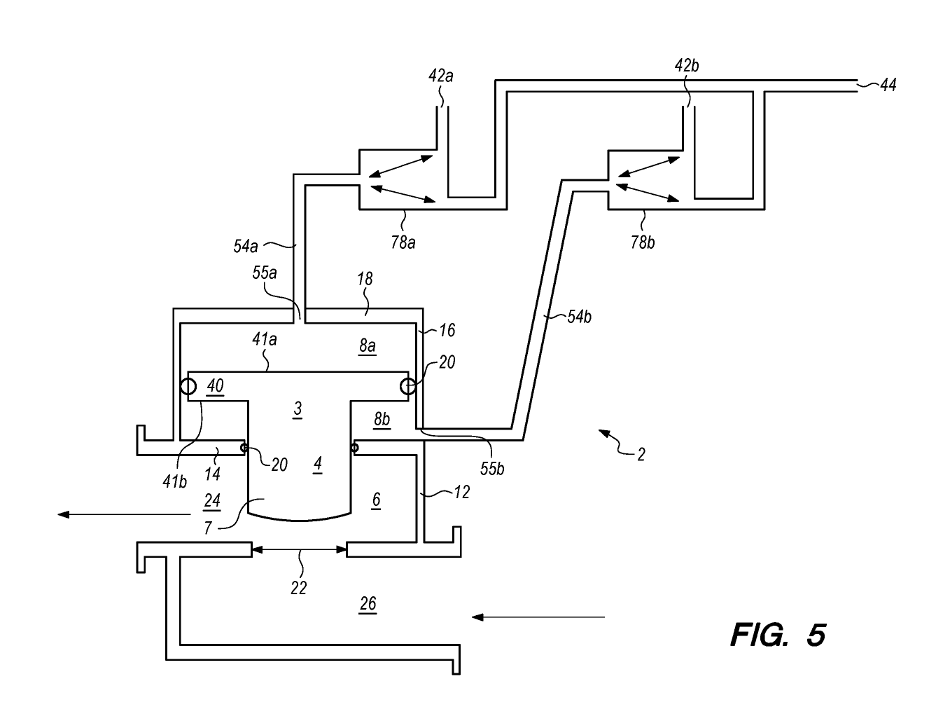

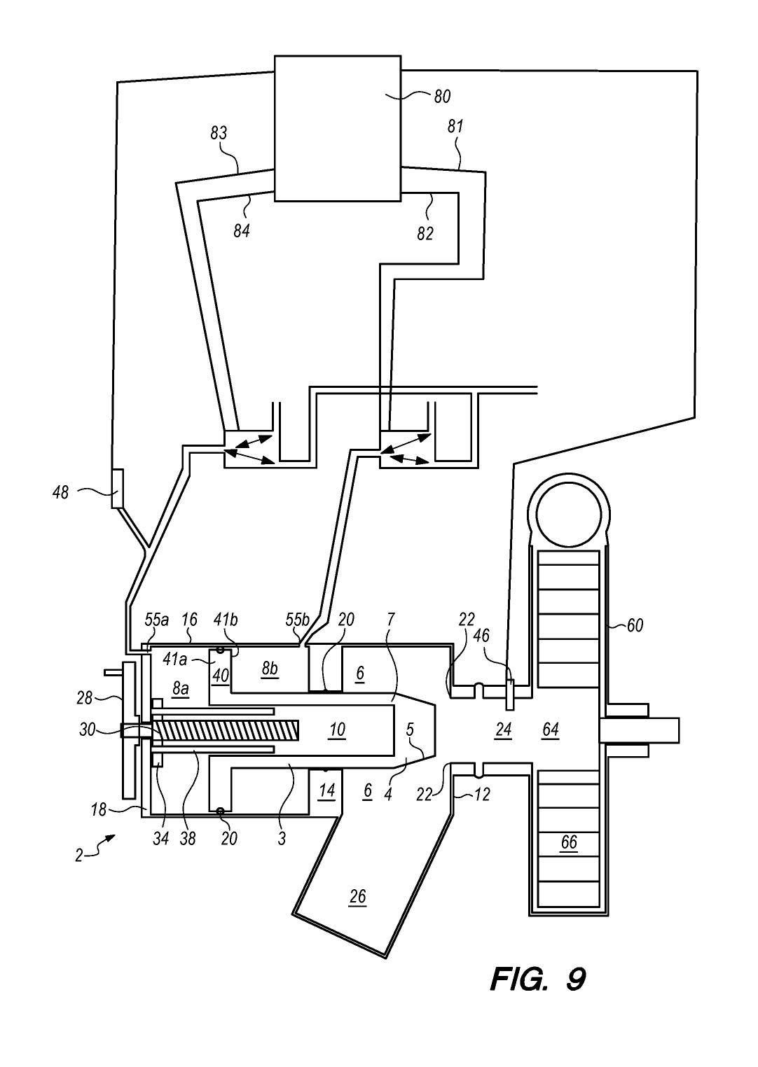

In a third mode configuration, as shown generally in FIGS. 2 and 5, and more particularly in FIG. 9, transducers 46, 48 positioned at various points may communicate with a controller 80 to selectively modify the positioning of the valves 78a, 78b on each of the rear 54a and forward 54b pressure supply lines based on the pressure readings at the various transducers 46, 48. For example, as shown in FIG. 9, a transducer 48 positioned at the rear pressure chamber supply line 54a relays the pressure in the rear pressure chamber 8a to the controller 80 and a transducer 46 positioned at the pump inlet 64 (i.e. at the flow outlet area 24 of the regulator 2) relays the pressure at the flow outlet area 24 and pump inlet 64 to the controller 80. If a certain pressure is desired in the rear pressure chamber 8a, the controller 80 may react to pressure readings outside of the desired range. For example, if a pressure between 40-45 psi is desired in the rear pressure chamber 8a, the controller 80 may, upon a reading of less than 40 psi at transducer 48, direct pressurized air into the rear chamber 8a and, upon a reading of greater than 45 at transducer 48, direct pressure from rear pressure chamber 8a to vent through the air line 54a, valve 78a, and vent 42a connected to the rear chamber 8a. Likewise, when a higher than desired pressure is recorded by the transducer 46 at the pump inlet 64, the controller 80 directs the pressure to increase in the rear pressure chamber 8a to move the valve toward the closed position. Alternatively, based on the pressure recorded by the transducer 46 at the flow outlet area 24, the controller 80 may direct the valve 78b on the line 54b connected to the forward pressure chamber 8b to introduce pressure or vent pressure from the forward pressure chamber 8b. It is contemplated that in the event of loss of air pressure or the failure of the controller 80, a manual valve may be implemented to manually vent air from the pressure chamber 8. At this point, pressure from liquid source exerting on the shaft 7 of the piston 3 may be used to move the piston 3 to the open position, while the hand wheel 28 may be used to dose move the piston 3 to the closed position or otherwise regulate the piston 3 movement. With regard to the transducer 46 placed at the flow outlet area 24, it is contemplated that locating the transducer 46 as close to the pump impellor as possible (as opposed to right at the start of the flow outlet area 24) allows for a more accurate regulation of pressure.

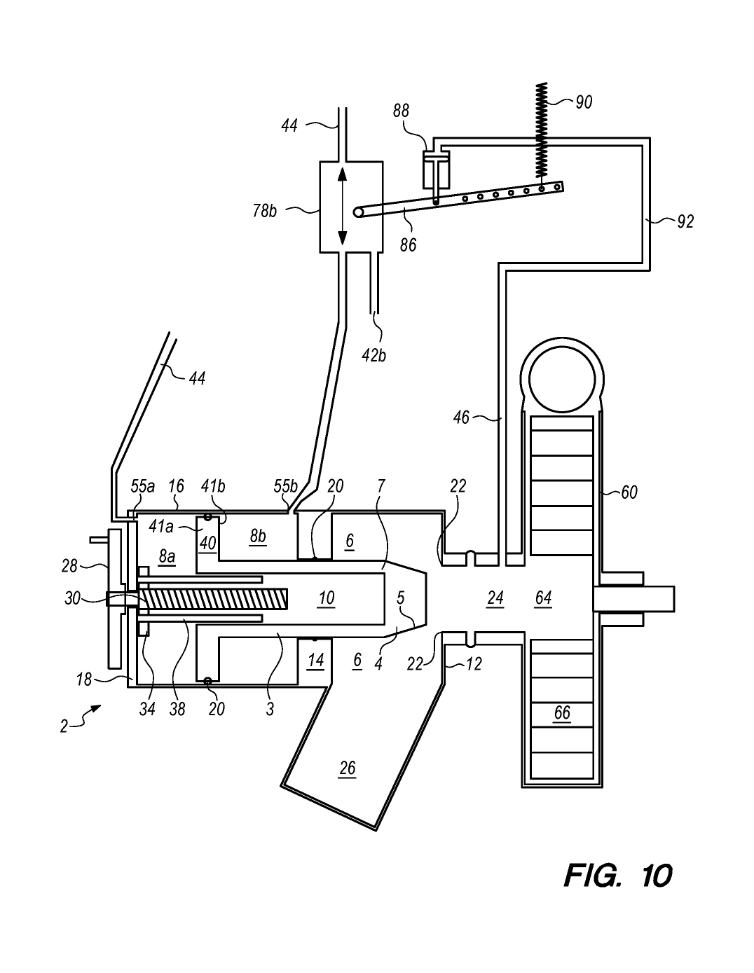

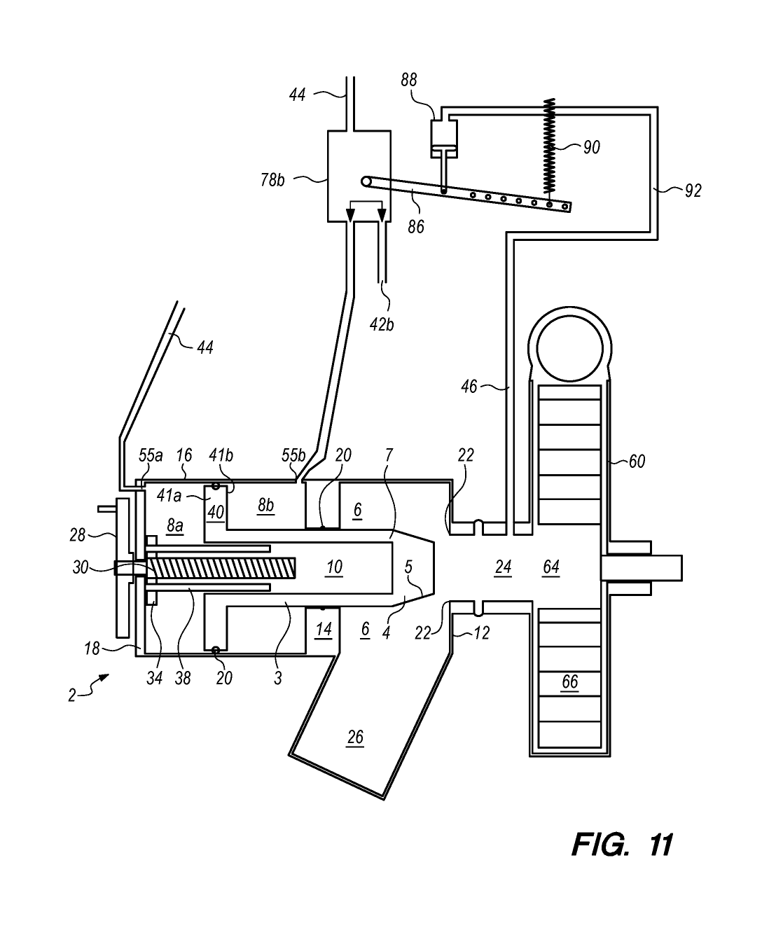

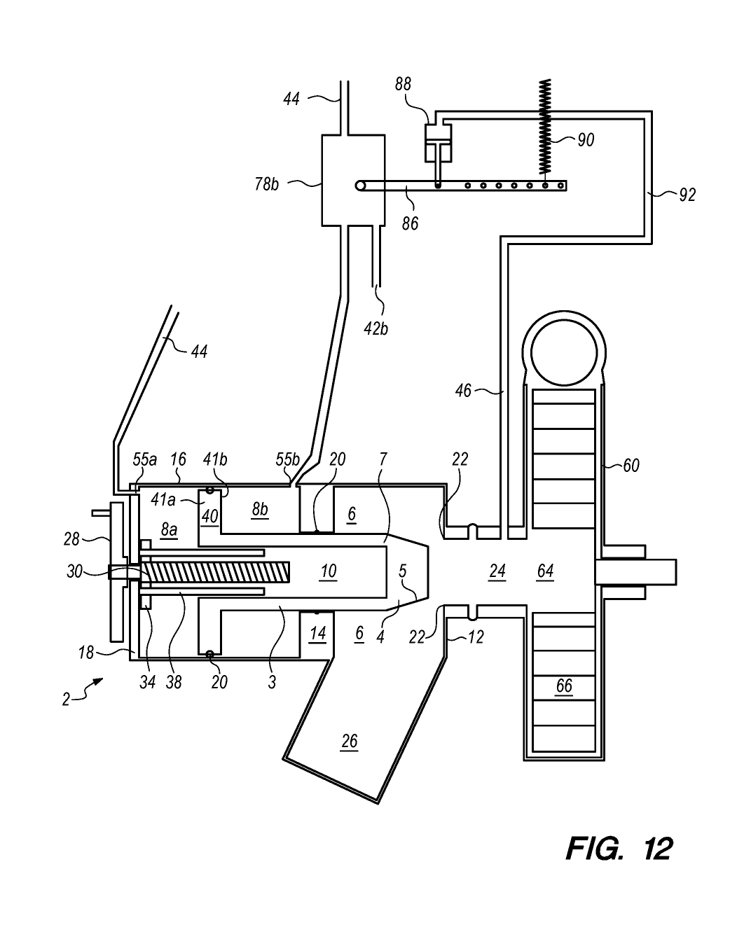

In one embodiment, the valve 78b on the forward pressure chamber supply line 54b is controlled by a cylinder 88, lever 86, and spring 90 assembly, as shown in FIGS. 10-12. The cylinder 88 comprises a piston that is inside a chamber fluidically connected to the flow outlet area 24 (i.e. the pump inlet area 64), such that change in pressure at the flow outlet area/pump inlet area 24/64 modifies the valve 78b based on movement of the cylinder 88 and lever 86 of the valve controlling assembly. The cylinder 88 and lever 86 move in various directions depending on the pressure exerted on the cylinder 88 by the liquid moving through a fluidic line 92 to the cylinder 88 from the pump inlet area 64. For example, as shown in FIG. 10, when the pressure of the fluid is too low to overcome the compression force of the spring 90, the lever is in an upward position, thus allowing the pressurized air to flow into the forward pressure chamber 8a of the regulator 2 through the valve 78b and supply line 54b. Should the pressure at the pump inlet 64 rise to a certain point such that it forces the cylinder 88 to compress, the lever 86 will be forced to move to a downward position, allowing for the venting of air pressure from the forward pressure chamber 8a through the valve 78b and vent 42b, as shown in FIG. 11. In either case, when the pressures balance, the lever 86 moves to a neutral position, as shown in FIG. 12, keeping the pressure steady until a pressure change causes movement of the lever 86 to occur to one of the supply or vent positions of the lever shown in FIGS. 10-11. Unless otherwise stated, all technical and scientific terms used herein have the same meaning as commonly understood by one of ordinary skill in the art to which this invention belongs. Although any methods and materials similar or equivalent to those described herein can also be used in the practice or testing of the present invention, a limited number of the exemplary methods and materials are described herein. It will be apparent to those skilled in the art that many more modifications are possible without departing from the inventive concepts herein.

All terms used herein should be interpreted in the broadest possible manner consistent with the context. When a grouping is used herein, all individual members of the group and all combinations and subcombinations possible of the group are intended to be individually included in the disclosure. All references cited herein are hereby incorporated by reference to the extent that there is no inconsistency with the disclosure of this specification. If a range is expressed herein, such range is intended to encompass and disclose all sub-ranges within that range and all particular points within that range.

The present invention has been described with reference to certain embodiment(s) that are intended to be exemplary only and not limiting to the full scope of the present invention as set forth in the following claims.

1. A pressure regulator for regulating the flow of a liquid from a pressurized liquid source, the pressure regulator comprising:
a. an inlet area;
b. an outlet area
c. a liquid flow chamber fluidically connecting the inlet area and the outlet area, wherein the liquid flow chamber comprises a sealing port, and wherein the liquid flow chamber is configured to receive an amount of the liquid from the inlet area;
d. a pressure chamber;
e. a dividing panel positioned between the liquid flow chamber and the pressure chamber, wherein the dividing panel comprises an aperture;
f. a piston comprising:
i. a plate, wherein the plate is positioned on a first side of the dividing panel and inside of the pressure chamber, wherein the plate divides the pressure chamber into a first pressure chamber section and a second pressure chamber section, wherein a first surface of the plate is positioned inside the first pressure chamber and a second surface of the plate is positioned inside the second pressure chamber;
ii. a shaft, wherein the shaft extends through the aperture of the dividing panel and into the liquid flow chamber;
g. a first fluid supply port fluidically connected to the first pressure chamber; and
h. a second fluid supply port fluidically connected to the second pressure chamber.

2. The pressure regulator of claim 1, wherein the first fluid supply port is configured to selectively introduce an amount of pressurized fluid from a pressurized fluid supply source into the first pressure chamber and the second fluid supply port is configured to selectively introduce an amount of the pressurized fluid into the second pressure chamber.

3. The pressure regulator of claim 2, wherein the receipt of the liquid into the liquid flow chamber exerts a force on the shaft of the piston, further wherein the introduction of the pressurized fluid into the first pressure chamber exerts a force on the first surface of the plate, and further wherein the introduction of the pressurized fluid into the second pressure chamber exerts a force on the second surface of the plate.

4. The pressure regulator of claim 3, wherein if the force exerted on the first surface of the plate is less than the sum of the force exerted on the second surface of the plate and the force exerted on the shaft of the piston, the piston is configured to move in a first direction within the pressure regulator.

5. The pressure regulator of claim 3, wherein if the force exerted on the first surface of the plate is greater than the sum of the force exerted on the second surface of the plate and the force exerted on the shaft of the piston, the piston is configured to move in a second direction within the pressure regulator.

6. The pressure regulator of claim 5, further comprising a first fluid supply line fluidically connected to the first fluid supply port and a second fluid supply line fluidically connected to the second fluid supply port, wherein each of the first fluid supply line and second fluid supply line are fluidically connected to the pressurized fluid supply source.

7. The pressure regulator of claim 6, wherein each of the first and second fluid supply lines comprises a valve.

8. The pressure regulator of claim 7, wherein the valve of each of the first and second fluid supply line comprises a vent.

9. The pressure regulator of claim 8, wherein the amount of pressurized fluid introduced to the first pressure chamber through the first supply port is selectively controllable by the valve on the first supply line and wherein the amount of pressurized fluid introduced to the second pressure chamber though the second supply port is selectively controllable by the valve on the second supply line.

10. The pressure regulator of claim 9, further comprising a controller configured to selectively control the valve on the first supply line and the valve on the second supply line, thereby selectively controlling the amount of pressurized fluid introduced into the pressure chamber.

11. The pressure regulator of claim 10, further comprising a microprocessor coupled to the controller and configured to send signals to the controller for selectively controlling the valve on the first supply line and on the second supply line.

12. The pressure regulator of claim 10, further comprising a transducer positioned on the first supply line, wherein the transducer is configured to record a pressure in the first pressure chamber and transmit a signal to the controller based on the recorded pressure in the first pressure chamber.

13. The pressure regulator of claim 11, wherein the controller is configured to selectively control the first valve based on the recorded pressure in the first pressure chamber.

14. The pressure regulator of claim 10, further comprising a transducer positioned in the outlet area, wherein the transducer is configured to record a pressure at the outlet area and transmit a signal to the controller based on the recorded pressure at the outlet area.

15. The pressure regulator of claim 14, wherein the controller selectively controls at least one of the valve on the first supply line and the valve on the second supply line based on the recorded pressure at the outlet area.

16. A pressure regulator for regulating the flow of a liquid from a pressurized liquid source by selectively introducing a pressurized fluid from a pressurized fluid source into the pressure regulator to selectively move the pressure regulator between a closed position to an open position, the pressure regulator comprising:
a. an inlet area;
b. an outlet area;
c. a liquid flow chamber fluidically connecting the inlet area and the outlet area, wherein the liquid flow chamber comprises a sealing port;
d. a pressure chamber;
e. a dividing panel positioned between the liquid flow chamber and the pressure chamber, wherein the dividing panel comprises an aperture;
f. a piston comprising:
i. a plate, wherein the plate is positioned on a first side of the dividing panel and inside of the pressure chamber, wherein the plate divides the pressure chamber into a first pressure chamber section and a second pressure chamber section, wherein a first surface of the plate is positioned inside the first pressure chamber and a second surface of the plate is positioned inside the second pressure chamber; and
ii. a shaft, wherein the shaft extends through the aperture of the dividing panel and into the liquid flow chamber;
g. a first fluid supply port fluidically connecting the first pressure chamber to the pressurized fluid source; and
h. a second fluid supply port fluidically connecting the second pressure chamber to the pressurized fluid source;
wherein when the pressure regulator is in the open position, the liquid is configured to flow from the pressurized liquid source into the liquid flow chamber through the inlet area and exit the liquid flow chamber through the outlet area and wherein when the pressure regulator is in the closed position, the shaft of the piston is configured to create a seal at the sealing port, thereby preventing flow through the pressure regulator.
